(19) United States
(12) Patent Application Publication
(10) Pub. No.: US 2010/0129595 A1
(43) Pub. Date: May 27, 2010

(54) Deceptive Security Screen Cover

(76) Inventors: Robert E. Linn, Phoenix, AZ (US); Joseph R. Kasa, Tempe, AZ (US)

Correspondence Address: LOEN PATENT SERVICES, 2266 S Dobson Road, Mesa, AZ, 85202, US

(21) Appl. No.: 12/548,142

(22) Filed: Aug. 26, 2009

Related U.S. Application Data
(60) Provisional application No. 61/117,452, filed on Nov. 24, 2008.

(51) Int. Cl. B32B 3/06

(52) U.S. Cl. 428/99

(57) ABSTRACT

The present invention is a deceptive security cover to hide important electronic equipment in a transportation vehicle from view. The deceptive security cover would look like a simple or low cost radio or CD player commonly found in transportation vehicles, or other common dashboard feature.

### CROSS REFERENCE TO RELATED APPLICATIONS

This application claims the benefit of U.S. Provisional Application No. 61/117,452, filed on Nov. 24, 2008.

### STATEMENT REGARDING FEDERALLY SPONSORED RESEARCH OR DEVELOPMENT

Not applicable.

### REFERENCE TO SEQUENCE LISTING, A TABLE, OR COMPUTER PROGRAM LISTING

Not applicable.

### BACKGROUND OF THE INVENTION

(1) Field of the Invention

This invention is directed toward security items for moving vehicles. In particular, it is directed toward covers and screens that hide important features of an automobile or truck from would be thieves so that it is difficult to view expensive items from outside of the vehicle.

(2) Description of Related Art

U.S. Pat. No. 4,480,675 describes a security cover for an automobile storage compartment. The security cover includes a flexible sheet material stretched between a rack pair. Although this provides a measure of security by hiding what is in the storage compartment, it does not provide a way of deterring thieves by misdirecting their attention as to believing incorrectly what is in the storage compartment.

U.S. D385284 shows a radio camouflage cover, but does not otherwise describe how it might be used or adapted for security of electronic components in a vehicle.

U.S. Pat. No. 4,960,623 describes a rectangular anti-theft device which is a panel cover that includes a number of exposed wires hanging in a way to create the illusion that a radio has already been stolen. Though this has some advantage of providing deception, common use of this cover by users will soon teach thieves that there is important electronic equipment behind the deceptive cover. This type of cover does not provide for a number of “faces” that allow for different “looks.” Thieves will see the deceptive cover on sale at stores and quickly learn what to look for. A deceptive cover with only one type of “look” is likely to do the opposite of what is intended, and draw attention to the vehicle.

U.S. Pat. No. 5,004,634 discloses a deceptive cover that uses a rectangular insert to place the cover over a cassette player, and the disclosure is specific for use in covering a cassette player. The disclosure mentions the desirability of using differing deceptive face plates, but does not disclose any methods of doing so. It is desirable, from a commercial standpoint, to have a deceptive faceplate that is able to provide a variety of deceptive looks from standardized inserts that can be customized by the user, and not utilize a standardized faceplate that will soon become recognized by thieves because it is commonly seen in cars or on the store shelf.

U.S. Pat. No. 6,741,166 describes a security apparatus for preventing the theft of motor vehicle electronic accessory units, such as compact disk players and radios, by use of a specially configured cable and attachment apparatus that prevents forward movement of the unit from the dash toward the passenger compartment. This has similar problems in that it fails to misdirect the attention of thieves into incorrectly believing what electronic equipment is installed in the dashboard.

Various cable locks are described in U.S. Pat. Nos. 6,003,348, 5,647,620, and U.S. Pat. No. 6,131,969. None of these patents describe deceptive means to misdirect or deceive a thief.

It is a burden for the owner of a transportation vehicle to provide for the removal of expensive electronic equipment from the transportation vehicle to prevent theft. This is inconvenient and unappealing for an owner of the vehicle as it requires a means to carry it around while performing normal activities such as shopping, attending festivities, attending sporting events, etc.

### BRIEF SUMMARY OF THE INVENTION

The present invention is a deceptive security cover for important electronic equipment in a transportation vehicle, in particular, trucks and automobiles. The electronic equipment to be covered includes valuable audio or visual equipment such as CD players, DVD players, VHS players, radios, MP3 players, navigation systems, high end sound systems, gaming systems, and other electronic entertainment systems commonly found in transportation vehicles. The deceptive cover is particularly useful for covering electronic equipment that is installed in the dashboard of a vehicle.

### BRIEF DESCRIPTION OF THE SEVERAL VIEWS OF THE DRAWING(S)

FIG. 1 shows a front view of one embodiment of the present invention, a deceptive cover.

FIG. 2 shows the back of the deceptive cover illustrated in FIG. 1.

FIGS. 3A-B shows the electronic equipment of a car dashboard without and then with a deceptive cover of the present invention.

FIG. 4 shows another view of the present invention, similar to FIG. 1.

FIG. 5 shows a back view of FIG. 4.

FIG. 6 shows frame parts that are useful for adapting the present invention to a variety of equipment sizes.

FIGS. 7-8 show another back view of the present invention.

### DETAILED DESCRIPTION OF THE INVENTION

An object of the present invention is to provide improved security for important electronic equipment in a transportation vehicle, and in particular, trucks and automobiles. The electronic equipment is valuable audio or visual equipment such as CD players, DVD players, VHS players, radios, MP3 players, navigation systems, high end sound systems, gaming systems, and other electronic entertainment systems commonly found in transportation vehicles.

Another important object of the present invention is to provide misdirection to any potential thief about the contents of the transportation vehicle. If the thief does not know there are valuable items within the vehicle, there is a significantly decreased likelihood that the vehicle will be targeted for burglary.

Another important object of the present invention is to provide for a security cover over electronic equipment that allows a high quality deceptive cover, that is, a deceptive cover where it is difficult during a visual inspection to determine that it is a deceptive cover.

Another important object of the present invention is to provide for a cover that readily fits over a variety of electronic equipment with a minimum amount of effort or adaptation.

Another important object of the present invention is to provide for a cover that is easily switchable with other deceptive covers.

Another important object of the present invention is to provide for a cover that is easily customized in a factory, so that multiple deceptive covers are readily obtainable in a production setting. This will reduce a thief's ability to spot a deceptive cover based on a memory of deceptive covers they have seen on a store shelf or in other vehicles.

Another important object of the present invention is to provide for a cover that does not damage delicate electronic equipment.

Another important object of the present invention is to provide for a deceptive cover that has a low profile, that is, the deceptive cover is reasonably thin so that the deception is properly maintained when in use.

Another important object of the present invention is to provide for a cover that is robust and is not damaged by the temperatures seen inside a transportation vehicle when stationary in a parking lot and exposed to outdoor conditions.

To these objects and ends, the following is a description of the figures in the present invention. The figures are illustrative of an important embodiment, but are not to be construed as restrictive as to the entirely conceived invention.

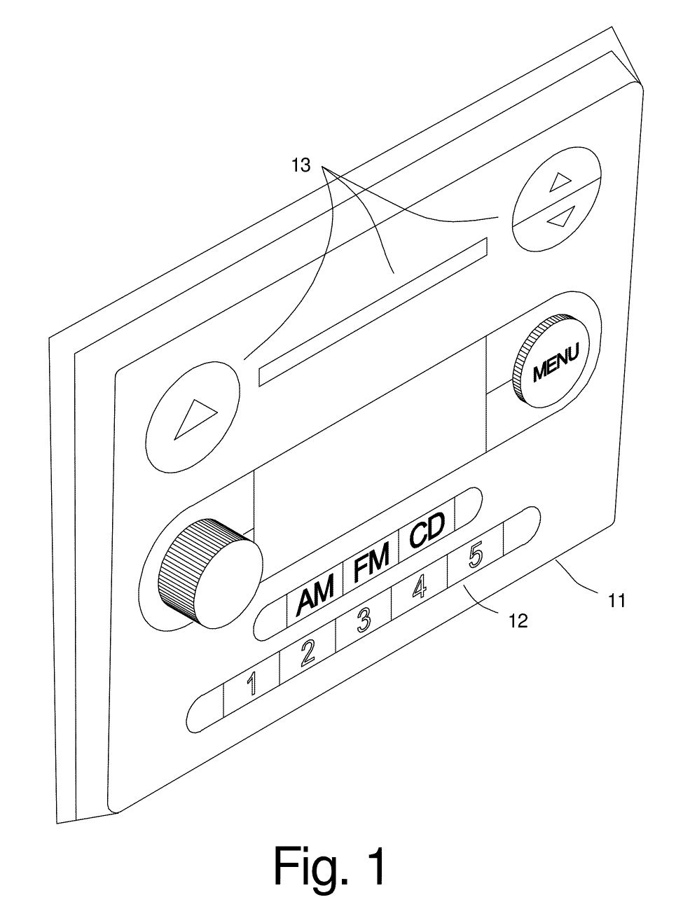

FIG. 1 is an embodiment of the present invention. A deceptive cover 11 made out of a plastic such as commonly used in an automobile or truck, is molded into the front piece or plate in the shape of a radio with a CD player. Radio buttons 12, which simulate station preset switches, are molded directly into the deceptive cover 11. At the top of the cover are a darkened slot and the push buttons 13 in a common arrangement for a CD player. By including both a simulated radio and pseudo slot for a CD player, this completes the deception for an inexpensive radio-CD player inside the vehicle. A thief would have little interest in a generic radio player and would most likely pass over this vehicle for burglary.

Important features that are preferably incorporated into the deceptive cover individually, or in combination are:

i) radio features

ii) CD player features

iii) glove compartment features

iv) HVAC features, and

v) features that are directed to primarily playing music.

It is helpful and important to provide for use such common features allow the ability to customize the deceptive cover faceplate in a factory production setting. Injection molding machine tooling can be set up to utilize various insert pieces, where the insert pieces create the common features just described. It is then convenient and cost effective to re-arrange the insert pieces in the injection tooling to re-arrange the appearance of the deceptive cover faceplate by using the same insert pieces in different locations in the injection molding tooling. Some features are installed after the faceplate is removed from the injection molding tooling, such as a protruding knob, and the base for where those features are installed can be adjusted by changing the location of insert pieces within the injection molding.

The deceptive cover of FIG. 1 is preferably made up of a variety of plastic materials, such as high density plastics, including recycled plastics. It is preferably made up of a durable plastic. A lightweight design is desirable. Alternately, the deceptive cover is also made from chrome, stainless steel, aluminum, various metals, or combinations of metal and plastic. The color would preferably be designed to match the interior of the vehicle, utilizing colors such as would be commonly seen in the interior of motorized vehicles.

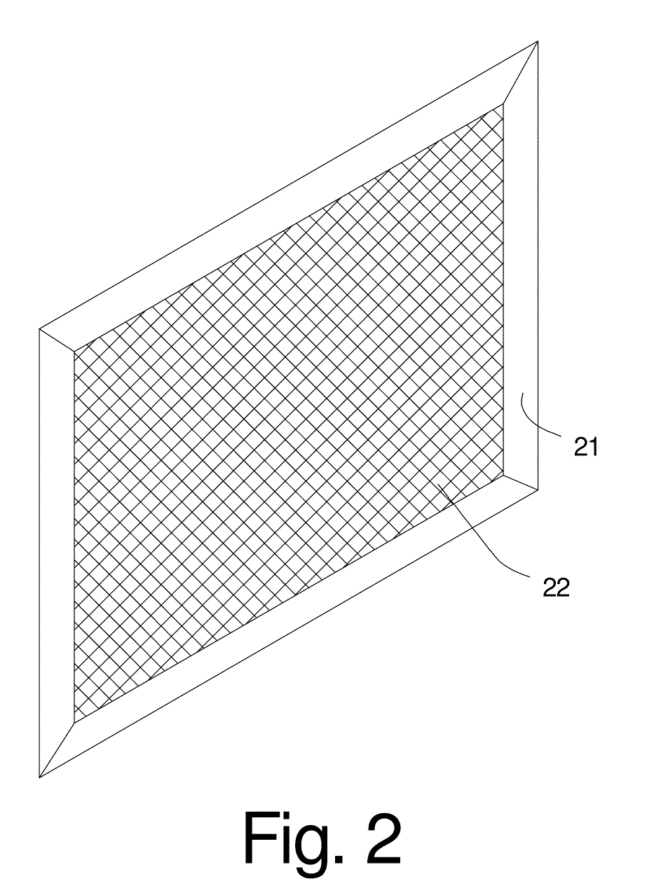

FIG. 2 shows the back of the deceptive cover illustrated in FIG. 1. An outside rectangular frame 21 is used to make a close fit around the electronic equipment to be covered. Inside the frame, and recessed within it, is a foam padding 22 that allows the deceptive cover to be placed directly upon the equipment being covered without concern for damage.

As an embodiment of the present invention, the deceptive cover is preferably sized large enough to cover up to a 4″×7″ rectangular display. This is accomplished by utilizing multiple foam pads which in turn fit inside the rectangular frame 21. The multiple foam pads then have different sizes that fit over the electronic equipment to be covered. The multiple foam pads attach to the rectangular frame by hook & loop or similar means.

The fit of FIG. 2 is only one embodiment of the present invention. Other methods could be used to attach the deceptive cover to electronic equipment and include just simply hanging the deceptive cover by the top edge. In two embodiments, the back of the cover is designed to fit snugly around a single DIN or double DIN size equipment. Head units generally come in either single DIN (180×50 mm panel) or double DIN (180×100 mm panel) size. The depth is not standardized. The US standard for a DIN radio is 2″×7″ and the Double DIN sized radio is a 4″×7″. International standard ISO 7736 defines a standard size for car audio head units. In a preferred embodiment, the deceptive cover is designed for fit over both the metric and the US standard.

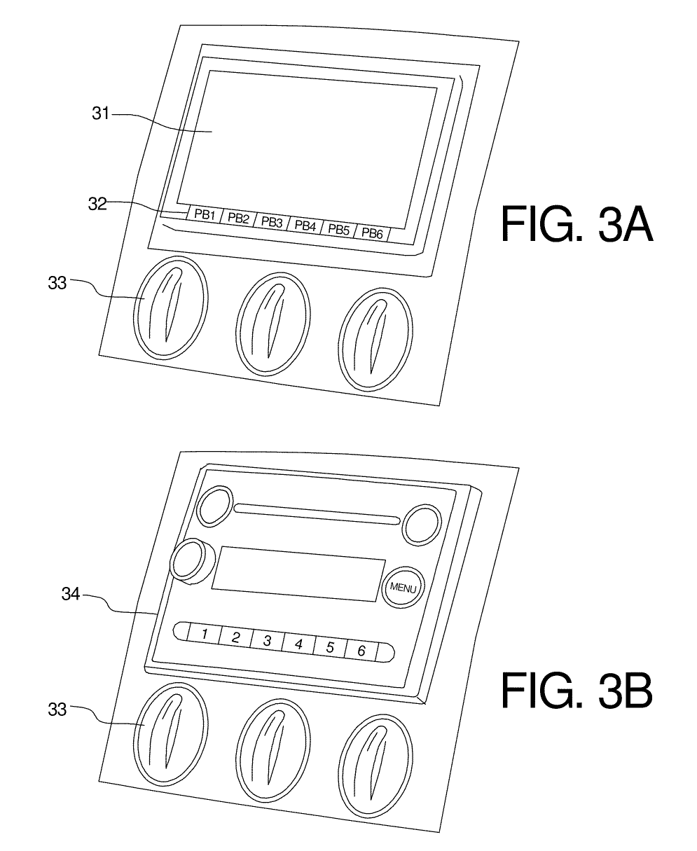

FIGS. 3A-B shows how the deceptive cover is actually used on an automobile dashboard and covers an expensive satellite touch screen radio 31 as seen in FIG. 3A. The satellite touch screen radio additionally includes important convenience buttons PB1-PB6 32 which need to be covered. Just below the radio are rotating knobs 33 which are used to control the HVAC system of the automobile. The deceptive cover 34, which is very similar to FIG. 1, is then placed over the satellite radio with a rectangular fit. This results in the finished look of FIG. 3B.

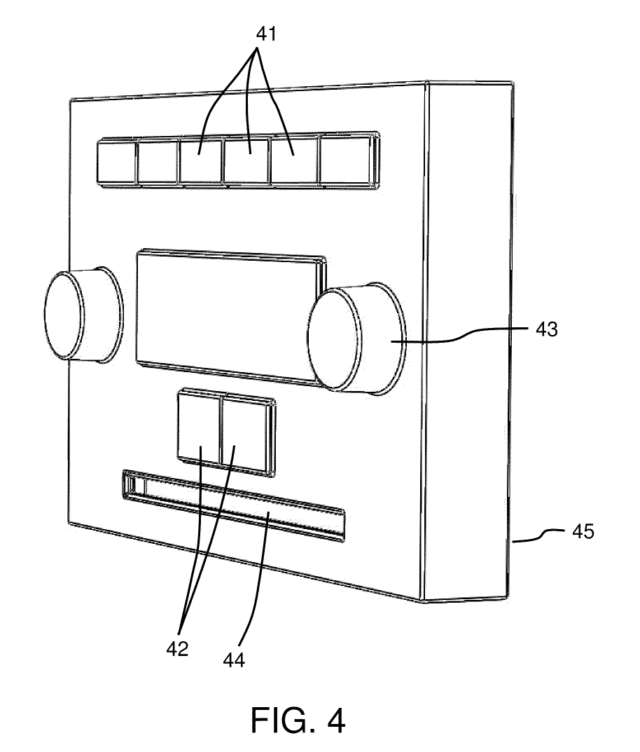

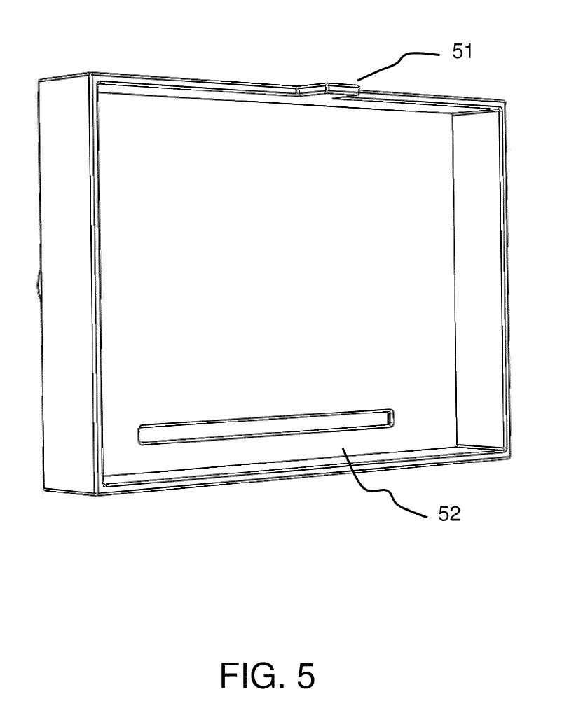

FIG. 4 shows another view of the present invention, similar to FIG. 1. Pseudo radio station preset buttons 41, CD player buttons 42, CD player slot 44, radio volume/station buttons 43, are attached to a front piece covering plate which has a back cover depression 45. The back of the covering plate is shown in FIG. 5.

FIG. 5 shows the deceptive cover back which is largely empty 51, and a protruding tab 52 at the top which is useful for mounting purposes.

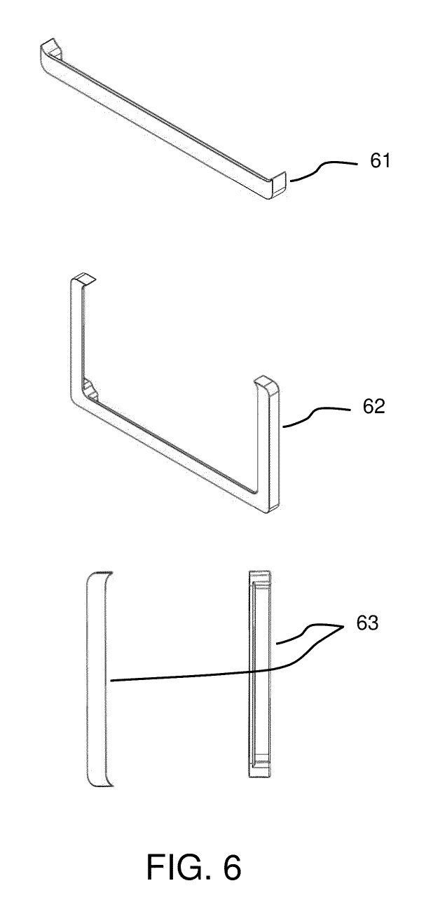

FIG. 6 shows various bracket parts that are useful for mounting the deceptive cover frame onto equipment of various sizes. For example, a horizontal bracket 61 can be used with two vertical brackets 63, to vary the rectangular dimensions of the present invention. The horizontal bracket 61 is mirrored to be the top and bottom brackets of a rectangle. A horseshoe bracket 62 is useful in some cases to simplify the mounting to existing equipment. It is combined with a horizontal bracket 61 to complete a rectangle if required. The bracket parts can be fitted together by various snug fit means, small screws, or they may fixed together by an adhesive bond, such as an epoxy. Alternately, they are permanently arranged by a combination of such methods. A rectangle is one embodiment of the present invention, but other geometrical shapes are also preferred. The exact method of fitting the deceptive cover over existing equipment would depend upon the equipment to be covered, any protruding knobs, and allowable spacing for the cover to fit in between existing surfaces. It is preferable for the mounting cover to be as flat as possible, and to press down as much as practical, so it appears visually to be an original part of the vehicle, and not a cover plate.

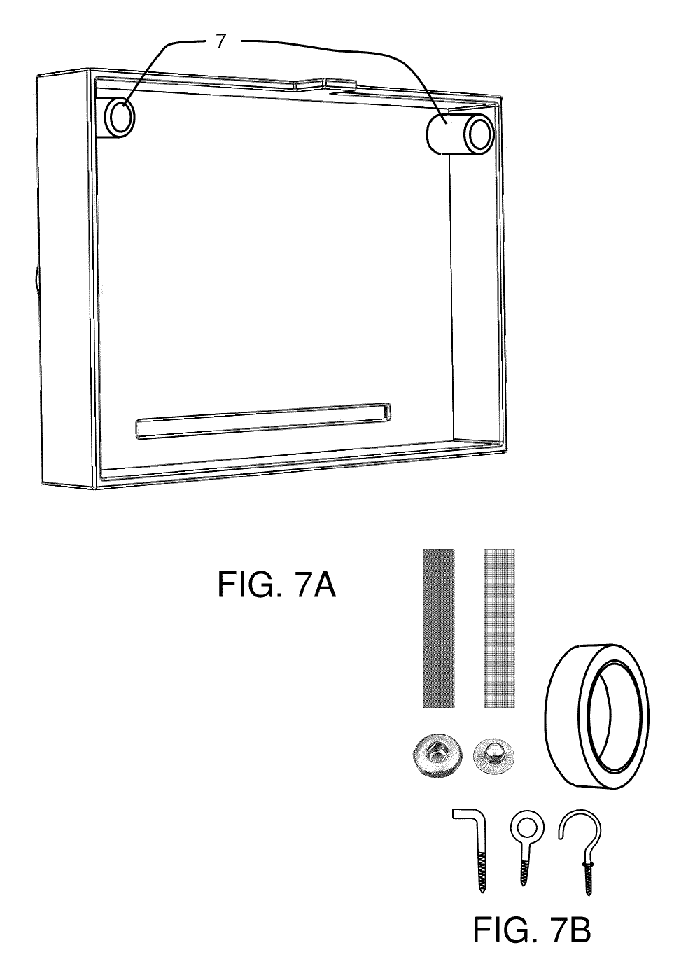

FIG. 7A shows another embodiment back view of the present invention. Pin holders 71 are used to mount the deceptive cover plate over pins that are located next to the equipment to be covered. FIG. 7B shows various additional hardware that is useful for mounting the present invention and include eyelets, hooks, snaps, adhesive tape, and hook & loop tape. The hardware shown in FIGS. 7A and 7B is not meant to be restrictive, but illustrative of the kinds of hardware that may be used. Other mounting hardware may be employed with equal success. The hardware is useful for creating attaching points nearby or within the electronic equipment to be hidden from view.

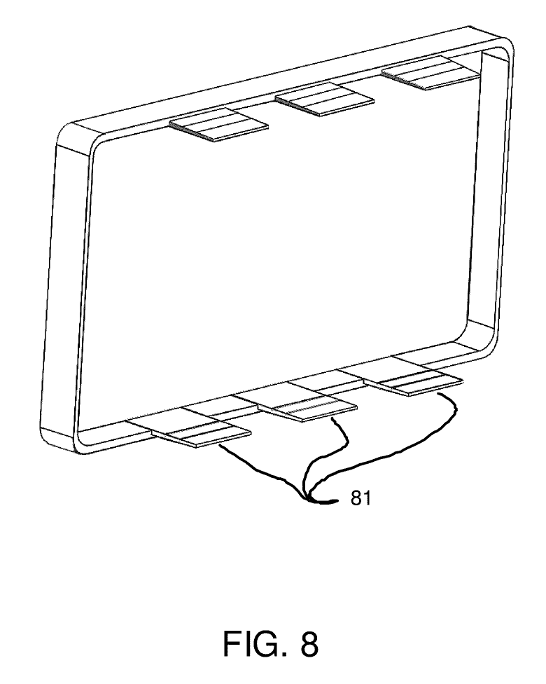

Alternately, FIG. 8 shows projecting tabs 81 which clip the deceptive cover plate to a frame permanently mounted nearby to the item to be covered. The projecting tabs could clip into hardware that is available near the item to be covered. The projecting tabs could also be placed nearby the item to be covered, and the back cover designed to receive the projecting tabs. However, in the later case it is important that the projecting tabs have a very short projecting dimension so as not to interfere with the operation of electronic equipment. In one alternate embodiment, the projecting tabs 81 are molded into the deceptive cover plate as one piece, or in another embodiment they are a separate item that is adhered to the back cover plate.

While various embodiments of the present invention have been described, the invention may be modified and adapted to various similar devices to those skilled in the art. Therefore, this invention is not limited to the description and figure shown herein, and includes all such embodiments, changes, and modifications that are encompassed by the scope of the claims.

We claim:

1. A deceptive cover for electronic equipment in a transportation vehicle comprising:
a) a front piece that incorporates non operable features,
b) incorporating a method of attaching said deceptive cover to:
i) said electronic equipment, or
ii) hardware located near said electronic equipment,
c) wherein said non operable features include at least one item selected from the group consisting of:
i) radio features,
ii) CD player features,
iii) glove compartment features,
iv) HVAC features, and
v) features that are directed to playing music,
d) wherein said deceptive cover substantially removes said electronic equipment from view for the purpose of concealing it.

2. The deceptive cover according to claim 1 wherein the location of said non operable features are customizable by re-arranging at least some tooling within injection molding that is used to create said deceptive cover.

3. The deceptive cover according to claim 1 wherein said deceptive cover is black or color matched to the interior of a vehicle.

4. The deceptive cover according to claim 1 wherein said deceptive cover fits over a single DIN size or double DIN size equipment, wherein said DIN size is defined by a metric standard or a US standard.

5. The deceptive cover according to claim 1 wherein the back of said deceptive cover is substantially rectangular, and the back of said deceptive cover is adjustable in size.

6. The deceptive cover according to claim 5 wherein the back of said deceptive cover incorporates at least one attachment that extends the length of the side, top, or bottom.

7. The deceptive cover according to claim 1 wherein said deceptive cover is primarily made from chrome, stainless steel, aluminum, or plastic.

8. A deceptive cover for hiding electronic equipment in a transportation vehicle comprising:
a) a front side that incorporates non operable features,
b) wherein said deceptive cover attaches to
i) said electronic equipment, or
ii) hardware located near said electronic equipment,
c) wherein said non operable features include at least one item selected from the group consisting of:
i) radio features,
ii) CD player features,
iii) glove compartment features,
iv) HVAC features, and
v) features that are directed to playing music,
d) wherein said deceptive cover is substantially made from plastic,
e) wherein said deceptive cover is substantially rectangular in shape and incorporates capabilities to adjust the width and height of said deceptive cover, and
f) wherein said deceptive cover is substantially color matched to the interior of said transportation vehicle,
whereby said deceptive cover is useful for substantially removing said electronic equipment from view.
